(19) United States
(12) Patent Application Publication
(10) Pub. No.: US 2007/0297809 A1
(43) Pub. Date: Dec. 27, 2007

(54) Optical Transmission/Reception Equipment And Optical Transmission/Reception Module

(75) Inventors: Takeshi Okada, Osaka (JP); Shinji Tsuji, Osaka (JP)

Correspondence Address: FISH & RICHARDSON P.C., P.O. BOX 1022, MINNEAPOLIS, MN, 55440-1022, US

(73) Assignee: SUMITOMO ELECTRIC INDUSTRIES, LTD., Osaka (JP)

(21) Appl. No.: 11/767,798

(22) Filed: Jun. 25, 2007

(30) Foreign Application Priority Data
Jun. 26, 2006 (JP) 2006-174776
Jun. 5, 2007 (JP) 2007-149398

(51) Int. Cl. H04B 10/00

(52) U.S. Cl. 398/164

(57) ABSTRACT

The present invention provides a method for connecting an optical transmission/reception module and a circuit board in order to reduce electrical crosstalk effectively in single-fiber bidirectional optical transmission/reception equipment. The optical transmission/reception equipment includes an optical transmission/reception module which has at least one transmission subassembly with a built-in light-emitting device, one or a plurality of reception subassemblies each having a built-in light-receiving device, and a housing for fixing the transmission subassembly and the reception subassembly/subassemblies, and a circuit board on which an electronic device is mounted. At least one stem base part constituting a stem/stems of the reception subassembly/subassemblies and a stem base part constituting a stem of the transmission subassembly are directly connected to a ground pattern of the circuit board.

### BACKGROUND OF THE INVENTION

1. Field of the Invention

The present invention relates to optical transmission/reception equipment used for single-fiber bidirectional communication and an optical transmission/reception module used for the same.

2. Description of the Background Art

Optical transmission/reception equipment used for single-fiber bidirectional communication mainly includes an optical transmission/reception module, a transmitter circuit part, and a receiving circuit part. First, an example of the prior art about a structure of the optical transmission/reception module will be described.

A light-emitting device and a light-receiving device are mounted on the optical transmission/reception module, and a laser diode (LD) and a photodiode (PD) are usually employed thereas. A stem is formed by making through holes in a stem base which is made by press-forming mild steel and plating the mild steel with gold (Au), inserting lead terminals used for connection of semiconductor devices into the through holes, and welding a case terminal to the stem base while the case terminal is being supported by low-melting glass. An optical device and an electronic device are mounted and wired on the stem, and sealed with caps having lenses to become subassemblies. The subassembly on which the light-emitting device is mounted is referred to as a transmission subassembly. The subassembly on which the light-receiving device is mounted is referred to as a reception subassembly. These subassemblies are inserted into a housing supporting optical filters, and the subassemblies and an optical fiber are aligned and fixed, which results in a module. Typically, the housing is larger than the subassemblies since the subassemblies are inserted into the housing (Patent Documents 1 through 3). Yttrium aluminum garnet (YAG) laser welding, which is a proven technique of laser welding capable of reliably fixing an optical axis for a long time, has been employed for fixing the housing, the LD, and the PD. Given this situation, stainless steel, which is appropriate for welding, has been used for the housing and the caps having lenses. Transmission light emitted from the LD is concentrated with the lens, travels through the optical branching filter, and enters the optical fiber. In contrast, reception light from the optical fiber is reflected by the optical branching filter, concentrated with the lens, and enters the PD. Such a structure realizes the single-fiber bidirectional communication.

Taking measures against crosstalk is important for the optical transmission/reception module which is formed by integrating the transmission subassembly and the reception subassembly in one housing. In particular, recently, a module size has been becoming smaller and a distance between the transmission subassembly and the reception subassembly has been decreasing, and thus, the taking of such measures is strongly demanded. Crosstalk includes optical crosstalk and electrical crosstalk. Electrical crosstalk is caused by electric waves or by current. Optical crosstalk is dealt with by measures such as increasing performance of an optical device and that of an optical filter and suppressing emittance of stray light. In contrast, electrical crosstalk is difficult to deal with because the transmission subassembly generates a strong pulse signal of a high repetition frequency while operating, and crosstalk caused by a large current in the transmission subassembly generates noise in the reception subassembly which receives a faint signal.

In the case of mounting the optical transmission/reception equipment used for single-fiber bidirectional communication in an appliance, the subassemblies constituting the optical transmission/reception module have been mounted on a circuit board on which a transmitter circuit part and a receiving circuit part are integrated, a circuit board divided for suppressing crosstalk, or a flexible circuit board. Here, the transmitter circuit part includes an LD driving circuit mounted on the transmitter circuit part, and the receiving circuit part includes a gain amplifier and the like mounted on the receiving circuit part. FIG. 4 shows a connection state of the optical transmission/reception equipment. The optical transmission/reception equipment is as follows. Lead forming is performed on lead pins 85, 85, . . . of an optical transmission part 83 and lead pins 86, 86, . . . of an optical reception part 84 of the optical transmission/reception module in order to alter end portions of the lead pins to be perpendicular to a circuit board 81. The lead pins 85, 85, . . . and the lead pins 86, 86, . . . are inserted into lead-pin connection holes provided in the circuit board 81, and are welded with solder from the back side of the circuit board 81. One of the lead pins of each of the optical transmission part and the optical reception part is a case terminal.

Such optical transmission/reception equipment has been normally used in digital transmission of a few hundred MHz or lower. Therefore, by connecting the transmission subassembly and the reception subassembly to the ground pattern via the case terminal of each of the stems, potentials of the stems, the caps, and the housing become equal to the ground. In addition, both crosstalk due to current and crosstalk due to electric waves can be suppressed even when a laser is driven and a current of a few tens of mA flows (Patent Document 4).

[Patent Document 1] Japanese Unexamined Patent Application Publication No. 6-160674

[Patent Document 2] PGT Japanese Translation Patent Publication No. 2003-524789

[Patent Document 3] Japanese Unexamined Patent Application Publication No. 2004-012647

[Patent Document 4] Japanese Unexamined Patent Application Publication No. 2005-217074

### SUMMARY OF THE INVENTION

However, recent optical transmission/reception modules used for single-fiber bidirectional communication have been required to have analog receiving parts in order to be applicable to high-speed digital transmission of 1.2 GHz or higher and correspond to video signals of optical cable television (CATV). In the case of receiving analog signals, for example, a ±0.5 dB band width of a frequency of 860 MHz for CATV or that of 1.3 GHz for retransmission of a broadcasting satellite (BS) signal needs to be ensured, and a low crosstalk characteristic of −60 dBc or lower against the level of the carrier is required even in the high-frequency domain.

If the optical transmission/reception modules are connected to a circuit board, connecting the transmission subassembly and the reception subassembly to the ground pattern only via the case terminal of each of the stems, as is conventionally done, is not sufficient. FIG. 9 shows a frequency spectrum up to 1 GHz of an output of the PD when the optical CATV video signal up to 460 MHz used for sixty channels and a video signal of 765.25 MHz are received while the LD is driven with an idle signal of the Gigabit Ethernet-Passive Optical Network (GE-PON) standard. The horizontal axis shows a signal frequency, and its units are MHz. The vertical axis shows a signal output voltage, and its units are dBμV. The resolution band width is 30 kHz. The video band width is 1 kHz. A video signal of 100 MHz through 460 MHz, a video signal of 765.25 MHz, and idle signals of the LD of around 500 MHz, 562.5 MHz, 687.5 MHz, 750 MHz, 812.5 MHz, 840 MHz, 875 MHz, and 937.5 MHz are seen. FIG. 10 shows a frequency spectrum up to 1 GHz of an output of the PD when the LD is driven with an idle signal of GE-PON standard, and no video signal is received. The horizontal axis shows a signal frequency, and its units are MHz. The vertical axis shows a signal output voltage, and its units are dBμV. The resolution band width is 30 kHz. The video band width is 1 kHz. Regardless of whether signal light is received or not, idle signals of GE-PON standard for driving the LD are seen around 500 MHz, 562.5 MHz, 687.5 MHz, 750 MHz, 810 MHz, 875 MHz, and 937.5 MHz in the case of driving only the LD. This is assumed to mean that while the ground cannot absorb electrical crosstalk generated from the LD when the LD is driven with a structure where the transmission subassembly and the reception subassembly are connected to the ground only via the case terminal of each of the stems, the case terminal itself works as an inductor of inductance (L).

A first object of the present invention is to provide a method for connecting an optical transmission/reception module and a circuit board in order to effectively reduce electrical crosstalk in single-fiber bidirectional optical transmission/reception equipment. A second object of the present invention is to provide an optical transmission/reception module for easily realizing this method.

Optical transmission/reception equipment of the present invention includes an optical transmission/reception module which has at least one transmission subassembly with a built-in light-emitting device, one or a plurality of reception subassemblies each having a built-in light-receiving device, and a housing for fixing the transmission subassembly and the reception subassembly/subassemblies, and a circuit board on which an electronic device is mounted. The optical transmission/reception equipment is characterized in that at least one stem base part among one or a plurality of stem base parts constituting a stem/stems of the reception subassembly/assemblies and a stem base part constituting a stem of the transmission subassembly are directly connected to a ground pattern of the circuit board.

The stem base parts of the transmission subassembly and the reception subassembly were directly connected to the ground pattern of the circuit board without using lead pins or the like therebetween. This reduced electrical crosstalk and resulted in preferable reception characteristics without any high-frequency noise even while the LD was driven.

If the stem bases of the transmission subassembly and the reception subassembly are connected directly to the ground pattern without using lead pins or the like therebetween, floating potentials of the stems are stably fixed, and thus high-frequency noise generated while the transmission subassembly is driven can be grounded. In particular, since both of the stem bases of the transmission subassembly and the reception subassembly are grounded, an optical transmission/reception module with low electrical crosstalk can be realized. The surface of the stem is Au-plated, and thus, solder-wettability is favorable in the case of soldering, electrical connection can be established easily, and electrical crosstalk can be reduced easily.

Direct connection of the housing to the ground pattern is not sufficiently effective. The housing is laser-welded in order to ensure high reliability when the optical axes of the transmission subassembly and the reception subassembly are fixed. Stainless steel is used as an optimal metal for welding in terms of corrosion resistance, strength, and cost.

However, stainless steel has large electric resistance compared with normal metals. Although mild steel SPCC material has an electric resistance of approximately 15 Ω·cm, stainless steel has an electric resistance of approximately 70 Ω·cm, which is 4 to 5 times larger than that of the mild steel SPCC material. Stainless steel has a large corrosion resistance but also has large electric resistance, and furthermore it is difficult to be soldered.

Even if the housing is connected directly to the ground pattern physically and forcedly, the housing cannot be sufficiently grounded because of its large electric resistance. A high-impedance part which is insufficiently grounded can be affected by various circuits, and thus its potential floats. In particular, the high-frequency noise generated in the transmission subassembly cannot be sufficiently grounded; therefore, part of the high-frequency noise extends to the reception subassembly and is superimposed as electrical crosstalk on a received signal.

Accordingly, if the stem base parts of the transmission subassembly and the reception subassembly are directly connected to the ground pattern of the circuit board, electrical crosstalk can be effectively reduced.

As a matter of course, the stem base part of the transmission subassembly and all of the stem base parts of the reception subassemblies may be directly connected to the ground pattern of the circuit board. This fixes floating potentials of all the stems, and an optical transmission/reception module with low electrical crosstalk can be realized.

The optical transmission/reception equipment of the present invention includes the optical transmission/reception module which has at least one transmission subassembly with a built-in light-emitting device, one or a plurality of reception subassemblies each having a built-in light-receiving device, and the housing for fixing the transmission subassembly and the reception subassembly/subassemblies, and the circuit board on which an electronic device is mounted. The optical transmission/reception equipment is characterized in that at least one stem base part among one or a plurality of stem base parts constituting a stem/stems of the reception subassembly/subassemblies and a stem base part constituting a stem of the transmission subassembly are directly soldered to the ground pattern of the circuit board. The stem base is Au-plated, and thus, solder-wettability is favorable and contact resistance becomes small.

The optical transmission/reception equipment of the present invention includes the optical transmission/reception module which has at least one transmission subassembly with a built-in light-emitting device, one or a plurality of reception subassemblies each having a built-in light-receiving device, and the housing for fixing the transmission subassembly and the reception subassembly/subassemblies, and the circuit board on which an electronic device is mounted. The optical transmission/reception equipment is characterized in that at least one stem base part among one or a plurality of stem base parts constituting a stem/stems of the reception subassembly/subassemblies and a stem base part constituting a stem of the transmission subassembly are fixed to the ground pattern of the circuit board with metal components such as a flange or the like. This reduces electrical crosstalk and results in preferable reception characteristics without any high-frequency noise even while the LD is driven.

The optical transmission/reception module mounted in the optical transmission/reception equipment of the present invention is characterized in that the module includes at least one light-receiving subassembly with a built-in analog photodiode which receives an analog signal light.

This connection method is particularly effective in the case of receiving analog signals of optical CATV that requires a demanding electrical crosstalk characteristic of −60 dBc against the carrier.

The optical transmission/reception module of the present invention is characterized in that a radius of the stem base part constituting the stem, the stem base part being directly connected to the ground pattern of the circuit board, is larger than the distance between the center of an axis of the housing of the optical transmission/reception module and a nearest-neighbor point of the housing from the circuit board. That is, the optical transmission/reception module is characterized in that the stem base part extends toward the circuit board more than the housing. Such a structure can easily connect the stem base to the ground pattern directly without any specially structural or wiring artifices.

The optical transmission/reception module of the present invention is characterized in that a portion of the stem base part that contacts the ground pattern is a plane. Such a structure can connect the stem base part constituting the stem to the ground pattern easily and stably, and increases productivity.

The optical transmission/reception module of the present invention is characterized in that the stem base part has a flange for performing direct connection to the ground pattern. Such a structure can easily connect the stem base to the ground pattern directly without any specially structural or wiring artifices.

The optical transmission/reception module of the present invention is characterized in that the flange provided at the stem base part has a portion of lower resistivity than a stainless steel which connects the stem base part and the ground pattern. Such a structure can deal with forming a cutout on the circuit board and providing the optical transmission/reception module in the cutout. That is, stem bases can easily be connected to the ground pattern directly without any structural or wiring artifices on a both-side mountable circuit board, and also a circumferential twist can be suppressed since the stem base parts are fixed. Such a structure can also realize compact optical transmission/reception equipment with low crosstalk.

As described above, electrical crosstalk can be reduced effectively by connecting stem bases of a light-emitting subassembly and a light-receiving subassembly to a ground pattern directly in optical transmission/reception equipment. An optical transmission/reception module that can easily reduce electrical crosstalk can also be realized.

### BRIEF DESCRIPTION OF THE DRAWING

FIG. 1A is a schematic diagram showing an arrangement of components of optical transmission/reception equipment of the present invention.

FIG. 1B is a sectional view taken along line A-A′ of FIG. 1A.

FIG. 2 is a diagram showing a state where a stem base of a subassembly of an optical transmission/reception module is directly connected to a ground pattern with solder in the optical transmission/reception equipment of the present invention.

FIG. 3 is a sectional view showing a structure of the optical transmission/reception module of the present invention.

FIG. 4 is a diagram showing a state where an optical transmission/reception module is connected to a circuit board in known optical transmission/reception equipment.

FIG. 5 is a diagram showing a state where a housing is connected to the circuit board in the known optical transmission/reception equipment.

FIG. 6 is a diagram showing a state where the stem base of the subassembly of the optical transmission/reception module is directly connected to the ground pattern with a flange in the optical transmission/reception equipment of the present invention.

FIG. 7 is a diagram showing a state where the stem base part with a planar portion, which is made by cutting a portion of the stem base part, of the optical transmission/reception module of the present invention is directly connected to the ground pattern of the circuit board of the optical transmission/reception equipment used for single-fiber bidirectional communication.

FIG. 8 is a diagram showing another example where the stem base part with the planar portion of the optical transmission/reception module of the present invention is directly connected to the ground pattern of the circuit board of the optical transmission/reception equipment used for single-fiber bidirectional communication.

FIG. 9 is a diagram showing a frequency characteristic of an output of a signal received by an analog-receiving circuit part in the optical transmission/reception equipment of the prior art when signal transmission/reception is performed.

FIG. 10 is a diagram showing a frequency characteristic of an output of a signal received by an analog-receiving circuit part in the optical transmission/reception equipment of the prior art when signal transmission is performed.

FIG. 11 is a diagram showing a frequency characteristic of an output of a signal received by an analog-receiving circuit part in the optical transmission/reception equipment of the present invention used for single-fiber bidirectional communication when signal transmission is performed.

FIG. 12A is a top view showing a state where the optical transmission/reception module of the present invention used for single-fiber bidirectional communication is mounted on the circuit board in which a cutout is provided.

FIG. 12B is a side view showing a state where the optical transmission/reception module of the present invention used for single-fiber bidirectional communication is mounted on the circuit board in which a cutout is provided.

### DETAILED DESCRIPTION OF THE INVENTION

Structures of the present invention will be described below in terms of embodiments, in which the present invention is applied to optical transmission/reception equipment. In all of the figures used to describe the embodiments, components having substantially the same functions are given the same reference numbers, and redundant description thereof is omitted.

### First Embodiment

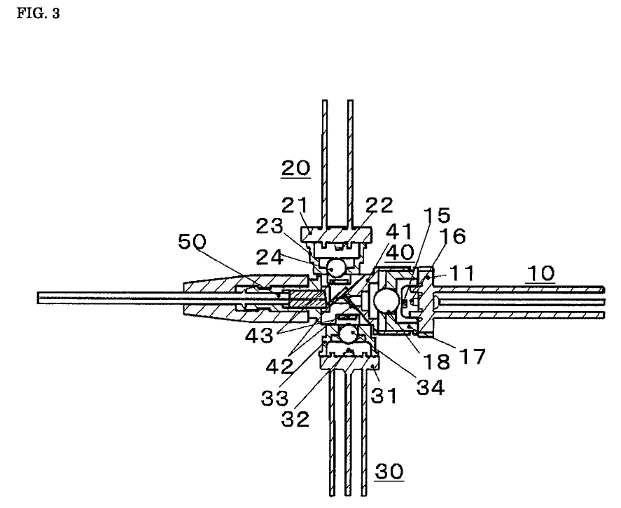

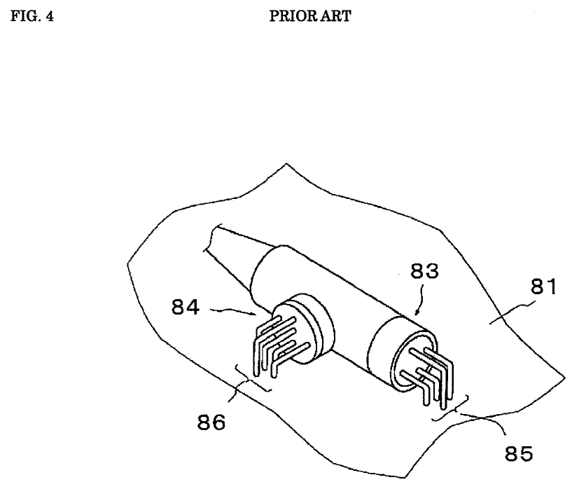

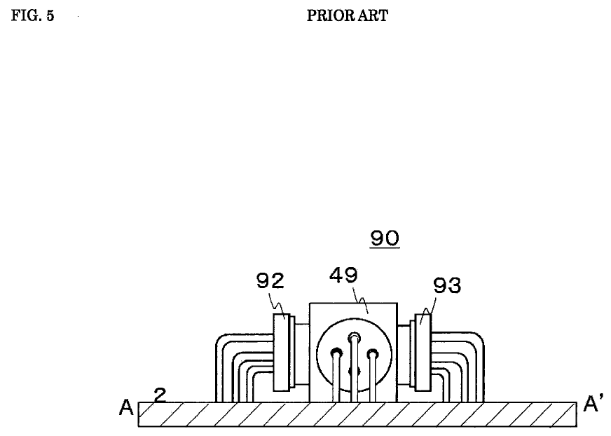

FIG. 3 is a sectional view showing a structure of a one-transmission-and-two-reception optical transmission/reception module used in a first embodiment of the present invention.

As shown in FIG. 3, an optical transmission/reception module 1 mainly includes a transmission subassembly 10, an analog-reception subassembly 20, a reception subassembly 30, a housing 40 for supporting optical filters, and an optical fiber 50. Such a module is used for transmission/reception in single-fiber bidirectional communication or in an optical subscriber transmission system.

The transmission subassembly includes a stem 11 on which an LD element 15, which emits transmission light of a wavelength λ1 (e.g., 1.3 um), is mounted, and airtightly seals the LD element 15 in a cavity formed by the stem 11 and a lens cap 17. A lens 18 is an aspheric lens made of lead glass; however, the lens 18 may be, for example, a spherical lens, depending on intended applications. The lens cap 17 is made of, for example, stainless alloy. The LD element 15 is, for example, a fabry-perot laser diode (FP-LD) having an active layer made of indium gallium arsenide phosphorus (InGaAsP) grown on an indium phosphorus (InP) substrate; however, the LD element 15 may be a distribution feedback laser diode (DFB-LD), depending on intended applications. The stem 11 is made of mild steel and plated with gold (Au).

The reception subassembly 30 includes a stem 31 on which a PD element 32, which emits reception light of a wavelength λ2 (e.g., 1.49 μm), is mounted, and airtightly seals the PD element 32 in a cavity formed by the stem 31 and a lens cap 33. A lens 34 is a spherical lens made of, for example, berkelium (BK) 7. The cap 33 is made of stainless steel. The PD element 32 may employ, for example, a PIN-PD having a light-receiving layer made of InGaAs or may employ an avalanche photodiode having a light-receiving layer made of InGaAs. The reception subassembly 30 may have a structure in which a transimpedance amplifier integrated circuit (IC) (not shown) and a dye cap (not shown) as well as the PD element 32 are mounted and connected to one another. The stem 31 is made of mild steel and is Au-plated.

The analog-reception subassembly 20 includes a stem 21 on which a PD element 22, which is sensitive to reception light of a wavelength λ3 (e.g., 1.55 μm), is mounted, and airtightly seals the PD element 22 in a cavity formed by the stem 21 and a lens cap 23. A lens 24 is a spherical lens made of, for example, BK7. The cap 23 is made of stainless steel. The PD element 22 may employ a PIN-PD that maintains superior linearity in photo-electric conversion and has an intermodulation 2^{nd} order distortion IMD2 of −70 dBc or lower, the PIN-PD having, for example, a light-receiving layer made of InGaAs. The stem 21 is made of mild steel and is Au-plated.

The housing includes optical branching filters 42, optical cut-off filters 43, and a supporting case 41. The optical branching filter 42 is transparent to transmission light of the wavelength λ1, and reflective to reception light of the wavelength λ2. The optical branching filter is a wavelength-selective transparent mirror, and is formed so as to have branching characteristics by depositing a dielectric multilayer on, for example, barium borosilicate glass. The optical cut-off filter 43 is provided in order to enhance monochromaticity of the wavelength λ2 and to reduce optical crosstalk. This is also formed so as to have wavelength characteristics by depositing a dielectric multilayer on barium borosilicate glass. The supporting case 41, which is also a body of the housing, includes the optical branching filters 42 and the optical cut-off filters 43, and supports the transmission subassembly 10, the analog-reception subassembly 20, the reception subassembly 30, and the optical fiber 50. The supporting case 41 is made of stainless steel, which is suitable for welding, and constitutes the following so as to be integral by cutting: an optical path from the transmission subassembly 10 to the optical fiber 50, an inclined plane of about 45° for supporting the optical branching filter 42, an intercylinder plane for supporting the transmission subassembly 10, a cylindrical hollow for fixing the optical cut-off filter 43, and fixing plane onto which the analog-reception subassembly 20, the reception subassembly 30, and the optical fiber 50 are fixed.

An assembling procedure is as follows. First, the optical branching filter 42 and the optical cut-off filter 43 are adhered to the supporting case 41 of the housing with ultraviolet (UV) curable resin. Next, after the optical fiber 50 and the transmission subassembly 10 are inserted into the supporting case 41 and aligned, the supporting case 41 and the transmission subassembly 10 are fixed by YAG laser welding. Afterwards the optical fiber 50 is aligned again, and the optical fiber and the housing are fixed likewise by YAG laser welding. Next, the reception subassembly 30 and the analog-reception subassembly 20 are aligned and fixed likewise by YAG laser welding.

The optical transmission/reception module according to the present invention aligns the LD and the optical fiber in a direction of the optical axis by sliding the transmission subassembly 10 along the direction of the optical axis. Thus, a distance between the optical branching filter 42 and the optical fiber 50 is always constant, which provides a characteristic that light-receiving sensitivity of the PD is not affected by the alignment of the LD. The optical transmission/reception module according to the present invention may have a one-transmission-and-two-reception structure having the reception subassembly 30 and the analog-reception subassembly 20 as described above, or may have a one-wavelength-transmission-and-one-wavelength-reception structure having one of the reception subassembly 30 and the analog-reception subassembly 20. For the PD mounted on the analog-reception subassembly 20, an analog-reception specialized PD, which suppresses a space-charge effect and maintains superior linearity in photo-electric conversion characteristics, may be used. In this case, the optical transmission/reception module is needed to further reduce crosstalk.

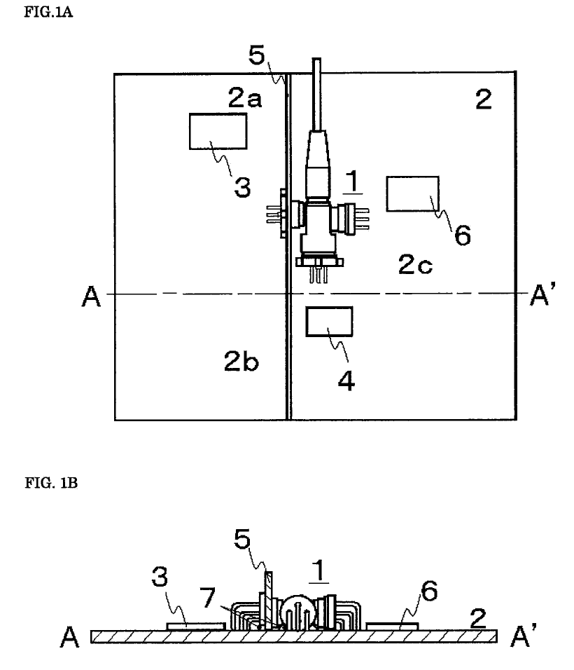

Next, the optical transmission/reception equipment employing the optical transmission/reception module will be described. FIG. 1 shows single-fiber bidirectional optical transmission/reception equipment of the present invention. The optical transmission/reception equipment includes a single-fiber bidirectional optical module 1, which has a one-transmission-and-two-reception structure, and a circuit board 2.

The circuit board 2 includes a transmitter circuit part 2b, a receiving circuit part 2c, and an analog-receiving circuit part 2a. The transmitter circuit part 2b has a power control function, an anomaly detection function, and an extinction ratio control function, and includes a LD driving IC 4 mounted thereon. The receiving circuit part 2c includes a digital-receiving IC 6 mounted thereon. The analog-receiving circuit 2a has a gain control function, and includes an analog-receiving IC 3, a gain amplifier, an impedance matching circuit, a reception light monitoring circuit (which are not shown), and the like mounted on the analog-receiving circuit 2a.

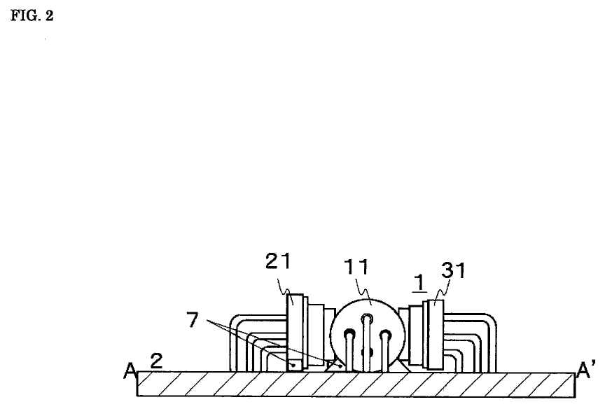

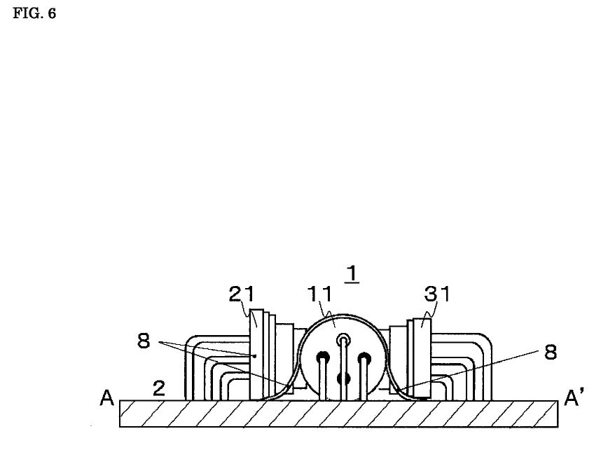

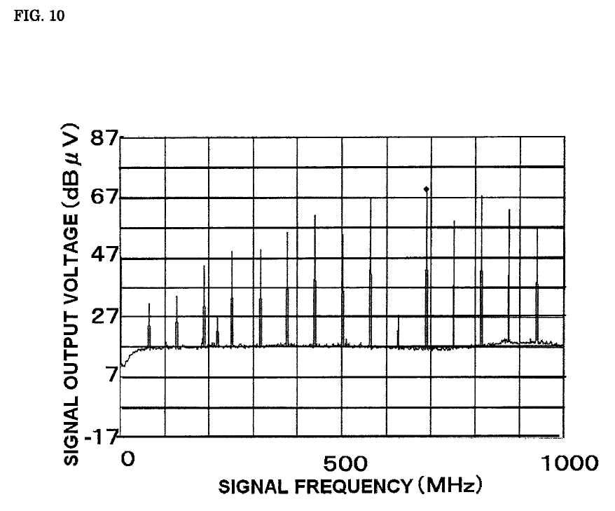

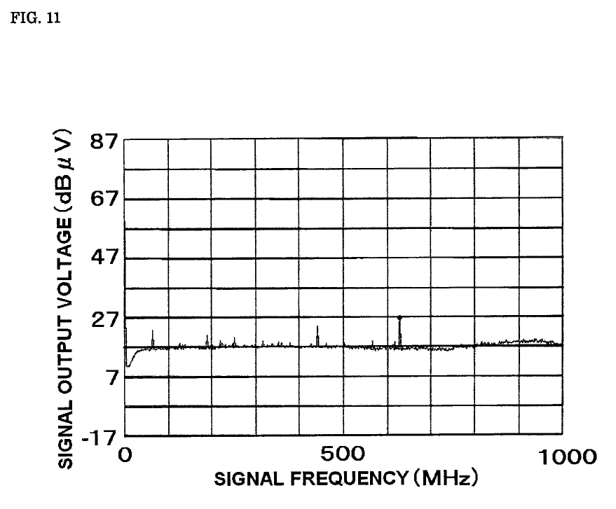

Each of lead terminals of the transmission subassembly 10 of the optical transmission/reception module is connected to the transmitter circuit part after lead forming is performed on the lead terminals. Each of lead terminals of the analog-reception subassembly 20 of the optical transmission/reception module is connected to the analog-receiving circuit part after lead forming is performed on the lead terminals. Each of lead terminals of the reception subassembly 30 of the optical transmission/reception module is connected to the analog-receiving circuit part after lead forming is performed on the lead terminals. Here, as shown in FIG. 2, stem base parts 11, 21, and 31 for the subassemblies are directly connected to a common ground pattern. Although direct-soldering 7 was employed to connect the stem base parts 11, 21, and 31 to the ground pattern, a metal component 8 such as a flange as shown in FIG. 6 may be used to fix the stem base parts 11, 21, and 31 to the ground pattern. Each stem base part can be easily connected to the ground directly if the optical transmission/reception module has a characteristic such that a radius of the stem constituting the stem base part, which is directly connected to the ground pattern of the circuit board, is larger than the distance between the center of an axis of the housing of the optical transmission/reception module and the nearest-neighbor point of the housing from the circuit board. In addition, a thin-copperplate shielding wall 5 may be provided between the analog-receiving circuit part and the transmitter circuit part, and may be directly connected to the common ground pattern. By taking such measures, noise due to electrical crosstalk was sufficiently suppressed at the receiving parts even in the case where a large current flowed while the LD was being driven. FIG. 11 shows a frequency characteristic of a received-light signal. The horizontal axis shows signal frequency, and its units are MHz. The vertical axis shows signal output voltage, and its units are dBμV. The resolution band width is 30 kHz. The video band width is 1 kHz. Noise peculiar to the LD as shown in FIG. 10 is not found.

### Second Embodiment

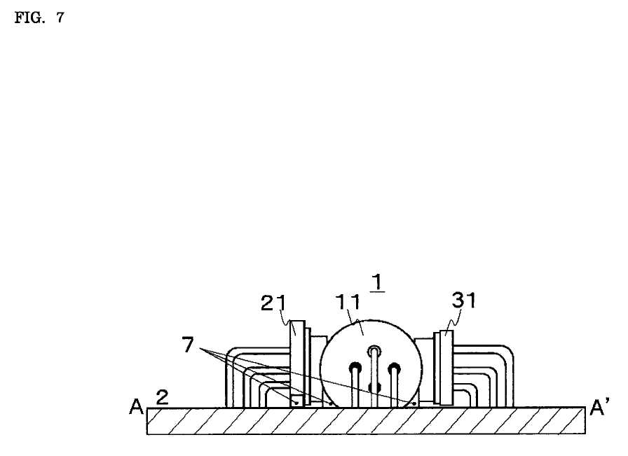

A structure of an optical transmission/reception module is the same as in the first embodiment. As shown in FIG. 7, stem base parts for a transmission subassembly and a reception subassembly of the optical transmission/reception module are designed to be larger than a housing of the optical transmission/reception module, and portions of the stem base parts adjacent to the circuit board are cut to have planar portions. This means that direct connection between package base parts and the ground pattern can be performed assuredly and easily. Electrical crosstalk was similarly reduced as shown in FIG. 11.

### Third Embodiment

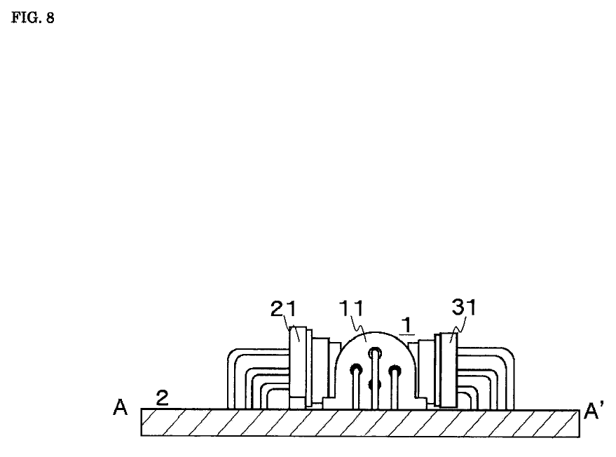

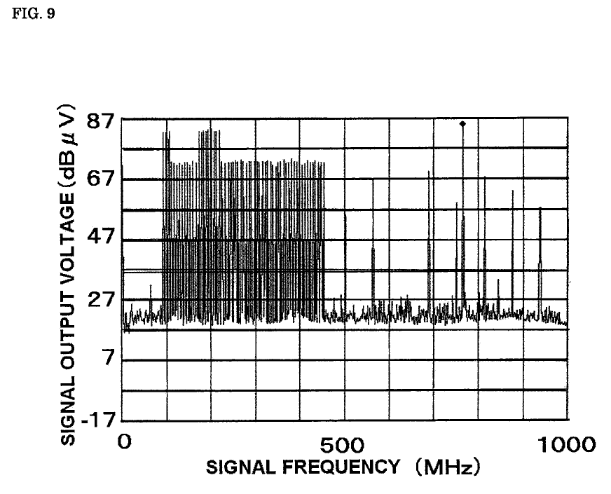

A structure of an optical transmission/reception module is the same as in the second embodiment. As shown in FIG. 8, adjacent portions of the stem base parts for the transmission subassembly and the reception subassembly to the circuit board are cut to have planar portions. This means that direct connection between package base parts and the ground pattern can be performed assuredly and easily. Electrical crosstalk was similarly reduced as shown in FIG. 11.

### Fourth Embodiment

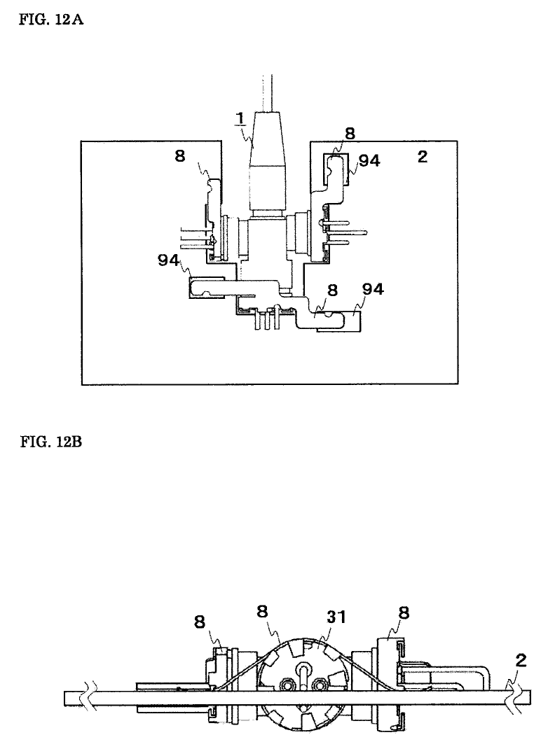

A structure of an optical transmission/reception module is the same as in the first embodiment. The optical transmission/reception module includes a flange, which is provided at the stem base part, for directly connecting the stem base part and the ground pattern of the circuit board. The flange is made of phosphor bronze and includes a gold-plated portion for connecting the stem base part and the ground pattern; however, a flange may be made of copper alloy or stainless steel with a gold-plated portion for connecting the stem base part and the ground pattern. The flange was soldered to the stem base part. As shown in FIG. 12A, a rectangular cutout was formed in the circuit board, and the optical transmission/reception module was disposed in the cutout. Note that ICs and a shielding board are omitted in FIG. 12A. Electrical crosstalk was similarly reduced as shown in FIG. 11 by connecting a lead of each of optical devices to a corresponding terminal of the circuit board and by connecting the stem base part directly to the ground pattern of the circuit board with the flange.

Although the embodiments and examples of the present invention have been described above, the disclosed embodiments and examples of the present invention are merely exemplary. Therefore, the scope of the invention is not limited to the embodiments. The scope of the invention is disclosed by the claims, and further includes all of the equivalents to the claims and all modifications within the scope of the invention.

1. Optical transmission/reception equipment comprising an optical transmission/reception module which includes at least one transmission subassembly with a built-in light-emitting device, one or a plurality of reception subassemblies each having a built-in light-receiving device, and a housing for fixing the transmission subassembly and the reception subassembly, /subassemblies and a circuit board on which an electronic device is mounted,
wherein at least one stem base part among one or a plurality of stem base parts constituting a stem/stems of the reception subassembly/assemblies and a stem base part constituting a stem of the transmission subassembly are directly connected to a ground pattern of the circuit board.

2. The optical transmission/reception equipment according to claim 1, wherein the direct connection is direct soldering of the stem base part to the ground pattern of the circuit board.

3. The optical transmission/reception equipment according to claim 1, wherein the direct connection is fixing the stem base part and the ground pattern of the circuit board with a flange.

4. The optical transmission/reception equipment according to claim 1, wherein the optical transmission/reception module includes at least one reception subassembly with a built-in analog photodiode which receives analog signal light.

5. An optical transmission/reception module incorporated in the optical transmission/reception equipment according to claim 1, wherein a radius of the stem base part constituting the stem, the stem base part being directly connected to the ground pattern of the circuit board, is larger than the distance between the center of an axis of the housing of the optical transmission/reception module and a nearest-neighbor point of the housing from the circuit board.

6. An optical transmission/reception module incorporated in the optical transmission/reception equipment according to claim 1, comprising at least one reception subassembly with a built-in analog photodiode which receives analog signal light, and characterized in that a radius of the stem base part constituting the stem, the stem base part being directly connected to the ground pattern of the circuit board, is larger than the distance between the center of an axis of the housing of the optical transmission/reception module and a nearest-neighbor point of the housing from the circuit board.

7. The optical transmission/reception module according to claim 5, wherein a portion of the stem base part that contacts the ground pattern is a plane, and the radius of the stem base part is a distance between a center of an exterior of the stem base part and the plane.

8. The optical transmission/reception module according to claim 6, wherein a portion of the stem base part that contacts the ground pattern is a plane, and the radius of the stem base part is a distance between a center of an exterior of the stem base part and the plane.

9. The optical transmission/reception module according to claim 5, wherein the stem base part has a flange for performing direct connection to the ground pattern.

10. The optical transmission/reception module according to claim 6, wherein the stem base part has a flange for performing direct connection to the ground pattern.

11. The optical transmission/reception module according to claim 9, wherein the flange has a portion of a lower resistivity than stainless steel which connects the stem base part and the ground pattern.

12. The optical transmission/reception module according to claim 10, wherein the flange has a portion of a lower resistivity than stainless steel which connects the stem base part and the ground pattern.
